(19) United States
(12) Patent Application Publication
(10) Pub. No.: US 2018/0150768 A1
(43) Pub. Date: May 31, 2018

(54) AUTOMATED GENERATION OF NATURAL LANGUAGE TASK/EXPECTATION DESCRIPTIONS

(71) Applicant: Gluru Limited, London (GB)

(72) Inventors: Theodosia Togia, Cambridge (GB); Michele Sama, London (GB); Tim Porter, London (GB)

(73) Assignee: Gluru Limited, London (GB)

(21) Appl. No.: 15/828,411

(22) Filed: Nov. 30, 2017

Related U.S. Application Data
(60) Provisional application No. 62/427,979, filed on Nov. 30, 2016.

(51) Int. Cl. G06N 99/00; G06F 17/27; G06F 17/24

(52) U.S. Cl. CPC G06N 99/005; G06F 17/279; G06F 17/2755; G06F 17/271; G06F 17/24

(57) ABSTRACT

Embodiments of the present invention are directed to computer-implemented methods and systems for automatically generating a description of a task or expectation. The method comprises receiving, in the form of an electronic communication, a natural language sentence that expresses a call or commitment to action; generating, using a machine learning model, a description of a task or expectation for a user based on the natural language sentence; and storing the description of the task or expectation in a non-transitory computer-readable memory.

### DESCRIPTIONS

The present patent application claims priority from U.S. Provisional Patent Application No. 62/427,979 filed Nov. 30, 2016, which is hereby incorporated by reference.

### TECHNICAL FIELD OF THE INVENTION

The present patent application relates in general to the technical field of machine learning, natural language understanding, and artificially intelligent agents or assistants used with modern electronic devices.

### BACKGROUND OF THE INVENTION

Network-connected computing devices are commonly used to store and share information quickly and reliably. A user typically receives information from a variety of heterogenous data streams. For example, heterogeneous data streams from which a user may receive information can include email applications, text messaging applications, chat applications, calendaring applications, task managers, to-do lists, project management applications, time trackers, daily planners, and the like. Because the amount of information and the number of data streams are increasing, manually keeping track of activities, tasks, intentions, expectations, actions, and triggering events found in the heterogenous data streams is an arduous task for most users. What is needed is way to automatically create and update tasks and expectations by reading signals from external data sources and understanding what users are doing and automatically completing tasks by reading signals from external sources and understanding when an existing task has been executed and an existing expectation has been met.

### SUMMARY OF THE INVENTION

Embodiments of the present invention are directed to a computer-implemented method for automatically generating a description of a task or expectation. The method comprises receiving, in the form of an electronic communication, a natural language sentence that expresses a call or commitment to action; generating, using a machine learning model, a description of a task or expectation for a user based on the natural language sentence; and storing the description of the task or expectation in a non-transitory computer-readable memory.

Other embodiments of the present invention are directed to a computer system comprising a processor, a network adapter coupled to the processor for receiving signals from a third-party system and sending signals to the third-party system, and a computer-readable memory coupled to the processor. The computer-readable memory is programmed with computer-executable instructions that, when executed by the processor, cause the computer system to perform the steps of: receiving, in the form of an electronic communication, a natural language sentence that expresses a call or commitment to action; generating, using a machine learning model, a description of a task or expectation for a user based on the natural language sentence; and storing the description of the task or expectation in a non-transitory computer-readable memory.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows the dependencies between the computer-implemented entities defined herein;

FIG. 2 shows an exemplary flowchart of a computer-implemented machine learning method for automatically generating natural language task descriptions and/or expectation description in accordance with embodiments of the present invention;

FIG. 3 shows an exemplary flowchart of a computer-implemented machine learning method for automatically generating natural language task descriptions and/or expectation description using semantic annotations;

FIG. 4 shows an exemplary flowchart of a computer-implemented machine learning method for automatically generating natural language task descriptions and/or expectation description where the natural language sentence is too verbose or includes discourse markers or irrelevant information;

FIG. 5 shows an exemplary flowchart of a computer-implemented machine learning method for automatically generating natural language task descriptions and/or expectation description using contextual knowledge describing the desired action;

FIG. 6 shows an exemplary flowchart of a computer-implemented machine learning method for automatically generating natural language task descriptions and/or expectation description using morphosyntactic characteristics of words;

FIG. 7 shows an exemplary flowchart of a computer-implemented machine learning method for automatically generating natural language task descriptions and/or expectation description using structured metadata; and

FIG. 8 is a block diagram showing a computer system suitable for storing and/or executing a computer program in accordance with embodiments of the present invention.

### DETAILED DESCRIPTION OF EMBODIMENTS

Embodiments of the present invention are directed to computer-implemented methods and systems that describe a task or an expectation resulting from a natural language sentence, embodied in an electronic communication (e.g., a telephone call or other voice signal, voice recognition output, an email, a text message, a chat message, a voicemail transcript, a real-time translation of a telephone call, etc.) which contains a call or commitment to action. A task represents an intention that a user can proactively accomplish (i.e., where the user is the one who can complete the intention). An expectation represents an intention that a user is expecting other parties to complete (i.e., when the user is waiting for the other party to complete the task associated with the same intention. An action is a suggested way of executing and completing a particular task.

For example, if user A sends an electronic communication to user B asking “Can you please fill in the form?”, then user B can be presented, on an electronic computing device, with a task described as “Fill in the form” and A can be presented, on an electronic computing device, with an expectation described as “Expect B to fill in the form”. Embodiments of the present invention improve the user experience by explicitly informing users what actions are pending and who is responsible for performing the action. Embodiments of the present invention can also enable third-party intelligent agents that utilize Natural Language Understanding (NLU) to assist users in performing the desired actions.

Embodiments of the present invention are suited for use with the system described in U.S. patent application Ser. No. 15/686,946 to Sama et al. (“Sama”), filed on Aug. 25, 2017, which is commonly owned by the Applicant of the present application and is incorporated by reference in its entirety into the present application. Sama describes a computer-implemented machine-learning method and system to understand, explain, learn, and predict the semantics of users' working habits so that other machines can be delegated to handle that knowledge for the purpose of visualising it, augmenting it or systematically completing repetitive operations and so that predicted habits can be shown to users allowing them to semi-supervise the execution if they wish to. Given input streams of semi-structured events received from user selected data sources such as emails, calendar, cloud filesystems, web services, and smart devices, a computer system programmed in accordance with embodiments of present invention automatically infers the semantics of what users are trying to accomplish and represents it in a format that captures long term goals as well as the sequence of interactions which will lead to its completion.

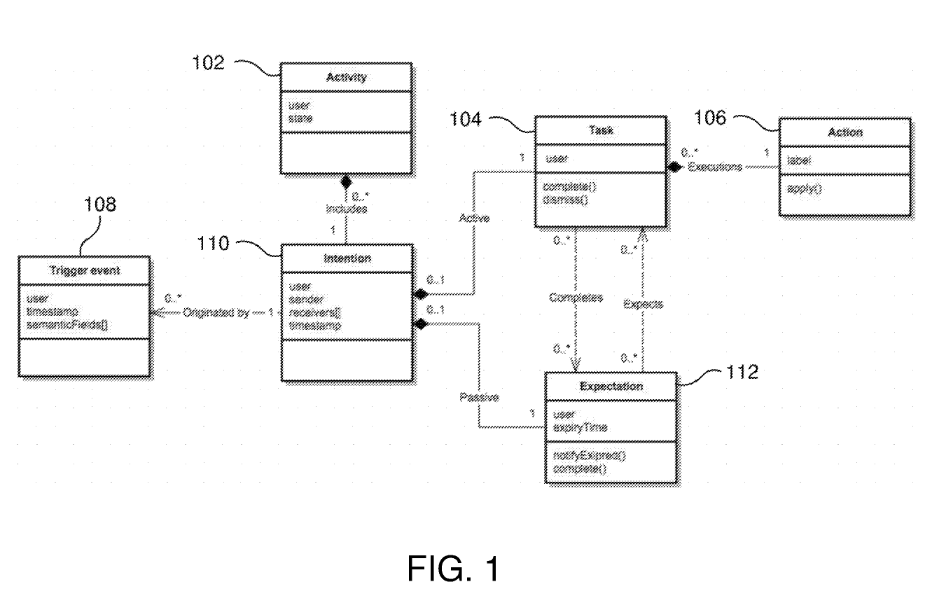

FIG. 1 shows the dependencies between the computer-implemented entities defined as follows:

Trigger event 108 is a heterogeneous message representation used to import signals from third party systems so that the signals can be processed for the purpose of inferring intentions. Activity 102 is the representation of a long-term goal achievable with sequence of interactions between the users involved. For example, activity 102 can comprise a salesman trying to sign a contract with a new lead. Intention 110 is the abstract understanding observed, inferred, or predicted that the user aims toward the completion of a certain goal to which he can either actively contribute or for which he will have to wait for external contributions. Intentions 110 are inferred from trigger events 108.

Task 104 represents an intention 110 that a user can proactively accomplish (i.e., where the user is the one who can complete the intention 110). Expectation 112 represents an intention 110 that a user is expecting other parties to complete (i.e., when the user is waiting for the other party to complete the task 104 associated with the same intention 110. An unmet expectation 112 will generate a trigger event 108.

Action 106 is a suggested way of executing and completing a particular task 104. Executed actions 106 on connected data sources may generate a trigger event 108. As users naturally progress on the execution of ongoing activities 102, tasks 104 and expectations 112 may need to be created updated, discarded or completed. By means of a subsystem named Gluru's Intention Lifecycle Engine (GILE), embodiments of the present invention allow both unsupervised and semi-supervised task management.

The semantic generation of intentions 110 is based on an extension of Gluru's Intention Inference Engine (GIIE) described in U.S. Patent Application Publication No. 2017/0131324 to Porter et al. (“Porter”), which is herein incorporated by reference in its entirety. In Porter, intentions 110 are represented as a list of contextual queries which would be used to search the information space. In embodiments of the present invention, intentions 110 are extended with semantics so that intentions 110 not only capture the context in which the user is operating but also capture the meaning of what the user is trying to accomplish.

Generation Given Speech Acts

When a sentence in an electronic communication is received as an input, embodiments of the present invention can automatically generate a task description for the sender and the relevant expectation description for the recipient. In a first example, Anna sends an electronic communication to Sam: “Three of us are going to the restaurant tonight, so can you please book as soon as possible?” The system automatically generates and stores a task description for Sam (recipient): “Book as soon as possible.” The system automatically generates and stores an expectation description Anna (sender): “Expect Sam to book as soon as possible.”

In a second example, Anna sends an electronic communication to Sam: “Three of us are going to the restaurant tonight, so I will book as soon as possible.” The system automatically generates and stores a task description for Anna (sender): “Book as soon as possible.” The system automatically generates and stores an expectation description for Sam (recipient): “Expect Anna to book as soon as possible.”

Generation Given Intended Actions

When the type of intended action is known, embodiments of the present invention can generate more sophisticated descriptions than the ones in the first example. Types of actions can be defined in advance, for example, in a hierarchical ontology of intended actions and predicted for a sentence using a purpose-built machine-learning classifier algorithm. Given knowledge of the intended action expressed in the sentence (e.g. ‘BOOK_A_TABLE’), descriptions can become more user-friendly. Below are examples of the same sentence as used in the previous examples, but with knowledge of the intended action taken into consideration.

In a first example, Anna sends an electronic communication to Sam: “Three of us are going to the restaurant tonight, so can you please book as soon as possible?” [Sentence has been semantically tagged with the intended action ‘BOOK_A_TABLE’.] The system automatically generates and stores a task description for Sam: “Reserve a table for three people for tonight.” The system automatically generates and stores an expectation description for Anna: “Expect Sam to reserve a table for three people for tonight.”

In a second example, Ian sends an electronic communication to Jess: “Please let me know if you are planning to register for the conference.” The natural language sentence has been semantically tagged with the intended action: ‘RSVP’. The system automatically generates and stores a task description for Jess: “RSVP regarding registration for the conference.” The system automatically generates and stores an expectation description for Ian: “Expect Jess to RSVP regarding registration for the conference.”

Using Sentence Compression

Embodiments of the present invention can isolate information related to the desired action and refrain from including unnecessary details in the generated description of the task or expectation. In a first example, Mary sends an electronic communication to Heather: “Sorry to bother you again but could you please get back to me with your signed document and a recent photo, so I can send it to my business partner?” The system automatically generates and stores a task description for Heather: “Send Mary your signed document and a recent photo.” The system automatically generates and stores an expectation description for Mary: “Expect Heather to send you her signed document and a recent photo.”

In a second example, Tony sends an electronic communication to Alex: “I need to head off now, but since you are very likely to run into problems setting up your workstation, I'll come back and help you, is that ok?” The system automatically generates and stores a task description for Tony: “Come back and help Alex.” The system automatically generates and stores an expectation description for Alex: “Expect Tony to come back and help you.”

Context-Aware Generation

Embodiments of the present invention can generate descriptions that are informed by the context of conversation or general knowledge about the users. For instance, if two users tend to interact via a particular medium (e.g. phone), this knowledge can be incorporated in the generated task/expectation descriptions. In a first example, John sends an electronic communication to David: “I'll get in touch tonight to discuss the details, OK?” From the system's knowledge that these two users tend to talk to each other on the phone, the system automatically generates and stores a task description for John: “Call David to discuss the details.” The system automatically generates and stores an expectation description for David: “Expect Tom to call and discuss the details.”

In a second example, Becky sends an electronic communication to Jack: “I believe your address is the one below, is that correct?” From the system's knowledge that the address below is 17 Willow Street EC2A, London, the system automatically generates and stores a task description for Jack: “Confirm that your address is 17 Willow Street EC2A, London.” The system automatically generates and stores an expectation description for Becky: “Expect Jack to confirm that his address is 17 Willow Street EC2A, London.”

Generation with Morphosyntactic Variation

Sentences expressing a call or commitment to action can contain words with particular morphological and/or syntactic characteristics. For instance, the word “trying” is the gerund form of the verb “try”. The syntactic pattern “Does x try?” is the interrogative form of “x tries”. Embodiments of the present invention are able to change the morphosyntactic characteristics of particular words or phrases in the original sentence in order to fit the generated description. As a result, particular words can change to their morphological variants (e.g. ‘make’ converted to ‘made’), other words can be omitted (e.g. ‘did’) and others can change positions (e.g. inverting “will he” to “he will”).

In a first example, Tom sends an electronic communication to Rachel: “Just curious, how did Jane make up her mind about this opportunity?” The system automatically generates and stores a task description for Rachel: “Inform Tom how Jane made up her mind about this opportunity.” The system automatically generates and stores an expectation description for Tom: “Expect Rachel to inform you how Jane made up her mind about this opportunity.”

In a second example, Laura sends an electronic communication to Dan: “Thank you for contacting Dr Jones' surgery; I will pass on your message to him.” The system automatically generates and stores a task description for Laura: “Pass on Dan's message to Dr Jones.” The system automatically generates and stores an expectation description for Dan: “Expect Laura to pass on your message to Dr Jones.”

Generation Leveraging Metadata

Embodiments of the present invention can leverage any available metadata to improve the generation of task/expectation descriptions. For instance, the name of the sender or recipient of the electronic communication can be used in generating the description, as can temporal or location information.

In a first example, Sarah sends an electronic communication to Mark in the month of Jun. “By the way, I ran into Greg at the office the other day and we were both wondering if you are still up for that project I described to you two months ago.” From the system's knowledge that “two months ago” relative to June is April, the system automatically generates and stores a task description for Mark: “Confirm that you are still up for that project that Sarah described to you in April.” The system automatically generates and stores an expectation description for Sarah: “Expect Mark to confirm that he is still up for that project that you described to him in April.”

In a second example, Gill sends and electronic communication to Sue from New York: “Hi Sue, what time is your plane landing here?” From the system's knowledge that Sue is in New York (e.g., from location data on the electronic device being used to send the electronic commuinication), the system automatically generates and stores a task description for Sue: “Confirm what time your plane is landing in New York.” The system automatically generates and stores an expectation description for Gill: “Expect Sue to confirm what time her plane is landing in New York.”

Exemplary Implementation

This system can be implemented using a model similar to those used in machine learning-based summarization and sentence compression. The problem can be approached either as that of selective summarization (i.e. selecting a portion of the sentence needed for the task or expectation to be described) or abstractive summarization (i.e. generating a different but shorter sentence to describe the task or expectation, possibly using different words, in a manner similar to that of Machine Translation).

Selective summarization solves a large part of the problem of describing tasks or expectations but needs to be supplemented by simple rules. For instance, from a sentence like “Please let me know if you are attending.” a selective model can select “you are attending” and a simple rule can generate “Confirm that you are attending”. Another sentence, such as “When is the bill due, please?” can be shortened into “when is the bill due” with a selective model but needs another rule to reverse “is” and “the bill” before getting further composed into, say, “ Inform Mary when the bill is due”. Selective summarization can be solved as a sequential prediction task. For example, in a sequence of words such as [‘please’, ‘let’, ‘me’, ‘know’, ‘if’, ‘you’, ‘are’, ‘attending’], a machine learning model can be trained to predict [O, O, O, O, O, B, I, I], using the Inside-Outside-Beginning (IOB) tagging format for tagging tokens in a chunking task in computational linguistics, meaning that the first five words are outside (O) our interesting sub-sequence, while the last three words are the beginning (B) and inside (I) the relevant sub-sequence. Sequential prediction can be performed with including Recurrent Neural Networks, which can be bi-directional, predict an output sequence after reading the entire input sequence and/or have gated cells such as Long-short Term Memory (LSTM), Gated Recurrent Unit (GRU), etc. Neural attention can also be incorporated in such a model.

Abstractive summarization can be used to generate descriptions of tasks and expectations by training a model not with IOB labels but directly with the target sequence, which creates a system that has very little dependence on rules prior to generation. An encoder-decoder neural architecture is a possible implementation for this type of generation.

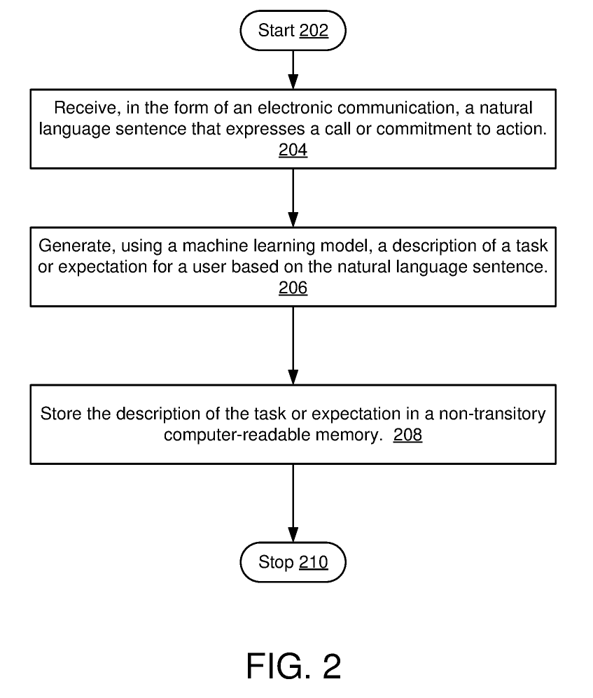

FIG. 2 shows an exemplary flowchart of a computer-implemented machine learning method for automatically generating natural language task descriptions and/or expectation description in accordance with embodiments of the present invention. Given a natural language sentence that expresses a call or commitment to action, embodiments of the present invention use a machine learning model that generates a description of a task and/or expectation for a user. The method begins at step 202. At step 204, the system receives, in the form of an electronic communication, a natural language sentence that expresses a call or commitment to action. At step 206, in response to receiving the electronic communication, the system automatically generates, using a machine learning model, a description of a task or expectation for a user based on the natural language sentence. At step 208, the system stores the description of the task or expectation in a non-transitory computer-readable memory. The method ends at step 210.

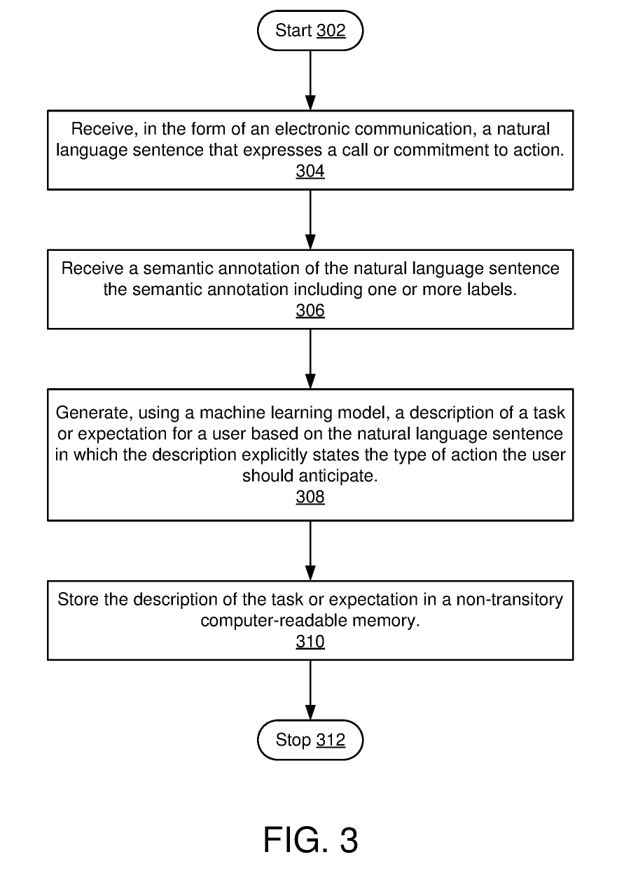

FIG. 3 shows an exemplary flowchart of a computer-implemented machine learning method for automatically generating natural language task descriptions and/or expectation description using semantic annotations. Given a semantic annotation of the natural language sentence with labels, manually assigned or predicted, and possibly derived from a hierarchical ontology of actions, it is possible to improve on the machine learning model used in FIG. 2 by generating a description that explicitly states the type of action that a user should perform or anticipate. The method begins at step 302. At step 304, the system receives, in the form of an electronic communication, a natural language sentence that expresses a call or commitment to action. At step 306, the system receives a semantic annotation of the natural language sentence in which the semantic annotation includes one or more labels. At step 308, in response to receiving the electronic communication, the system automatically generates, using a machine learning model, a description of a task or expectation for a user based on the natural language sentence in which the description explicitly states the type of action that the user should perform or anticipate. At step 310, the system stores the description of the task or expectation in a non-transitory computer-readable memory. The method ends at step 312.

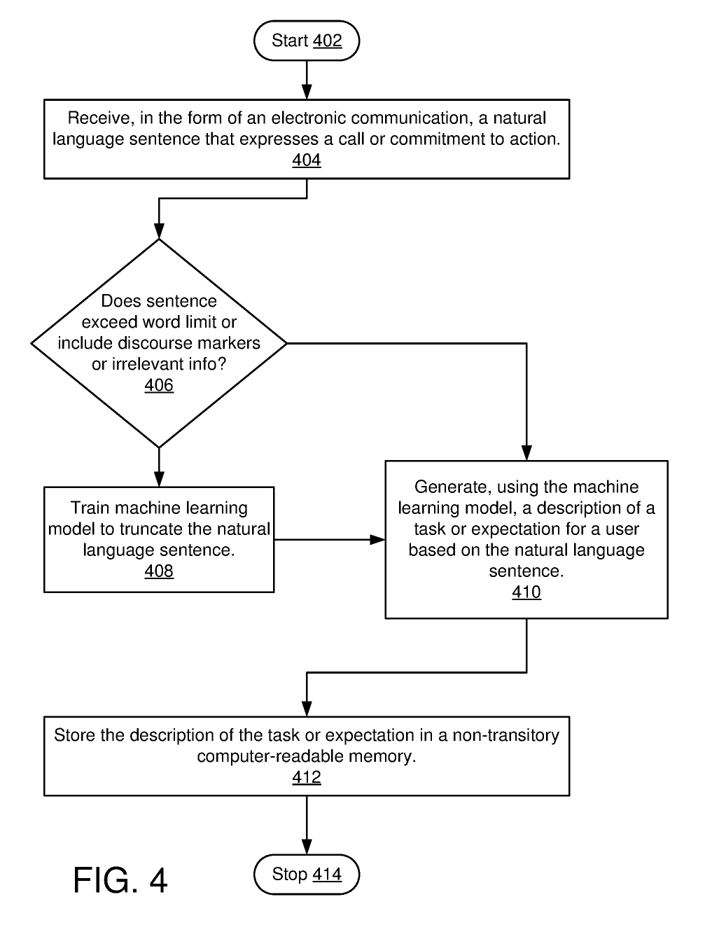

FIG. 4 shows an exemplary flowchart of a computer-implemented machine learning method for automatically generating natural language task descriptions and/or expectation description where the natural language sentence is too verbose or includes discourse markers or irrelevant information. It is possible to train the machine learning model in the method of FIG. 2 to truncate the sentence keeping only the task-related parts. The method begins at step 402. At step 404, the system receives, in the form of an electronic communication, a natural language sentence that expresses a call or commitment to action. At step 406, the system determines whether the natural language sentence exceeds a predetermined word limit or includes discourse markers or irrelevant information. At step 408, in response to the natural language sentence exceeding a predetermined word limit or includes discourse markers or irrelevant information, the system trains the machine learning model to truncate the natural language sentence so that only a portion of the natural language sentence related to the description of the task or expectation is kept. At step 410, in response to receiving the electronic communication, the system automatically generates, using a machine learning model, a description of a task or expectation for a user based on the natural language sentence. At step 412, the system stores the description of the task or expectation in a non-transitory computer-readable memory. The method ends at step 414.

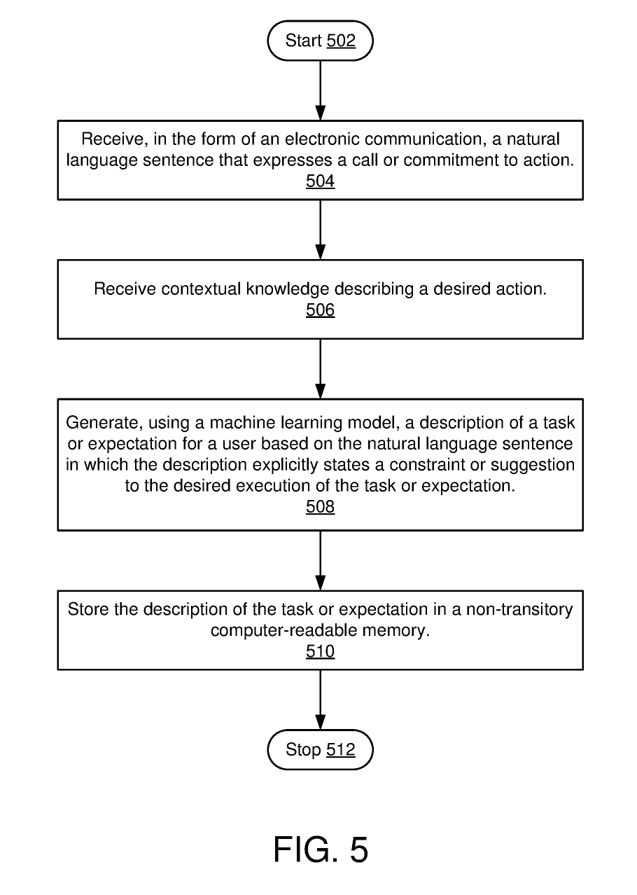

FIG. 5 shows an exemplary flowchart of a computer-implemented machine learning method for automatically generating natural language task descriptions and/or expectation description using contextual knowledge describing the desired action. Given any form of contextual knowledge describing the desired action, it is possible to improve on the machine learning model FIG. 2 by generating a description that explicitly stating constraints or suggestions to the desired execution including, but not limited to, the desired media and other action specific parameters such as time, location or preferences. The method begins at step 502. At step 504, the system receives, in the form of an electronic communication, a natural language sentence that expresses a call or commitment to action. At step 506, the system receives contextual knowledge describing a desired action. At step 508, in response to receiving the electronic communication and the contextual knowledge describing a desired action, the system automatically generates, using a machine learning model, a description of a task or expectation for a user based on the natural language sentence so that the description explicitly states a constraint or suggestion to the desired execution of the task or expectation. At step 510, the system stores the description of the task or expectation in a non-transitory computer-readable memory. The method ends at step 512.

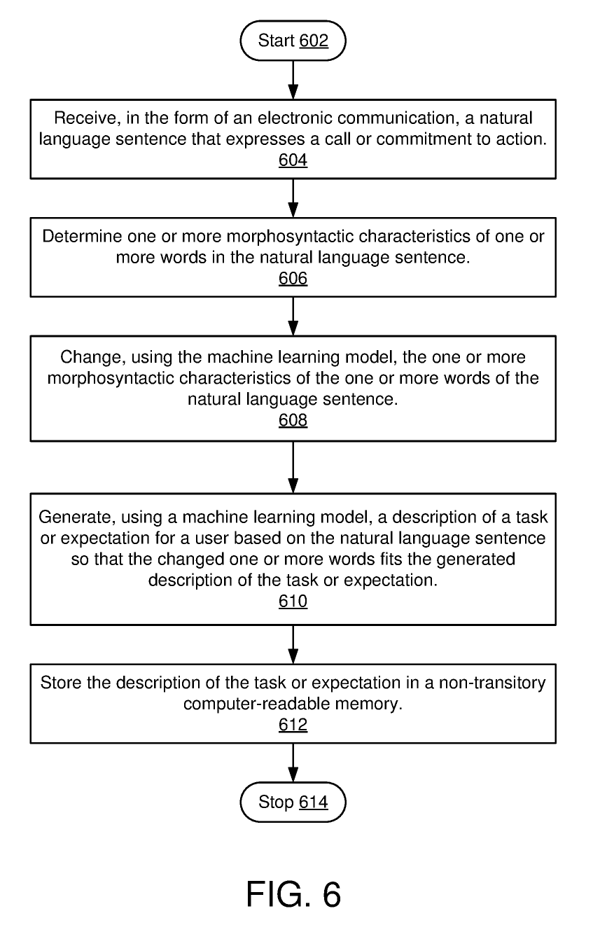

FIG. 6 shows an exemplary flowchart of a computer-implemented machine learning method for automatically generating natural language task descriptions and/or expectation description using morphosyntactic characteristics of words. Given morphosyntactic characteristics of personal pronouns, verbs or other words manifest in a natural language sentence, it is possible to use a machine learning model that can change these characteristics to fit the description of the generated task or expectation. The method begins at step 602. At step 604, the system receives, in the form of an electronic communication, a natural language sentence that expresses a call or commitment to action. At step 606, the system determines one or more morphosyntactic characteristics of one or more of the words in the natural language sentence. At step 608, the system changes, using the machine learning model, the one or more morphosyntactic characteristics of the one or more words of the natural language sentence so that the changed one or more words fits the generated description of the task or expectation. At step 610, the system automatically generates, using a machine learning model, a description of a task or expectation for a user based on the natural language sentence so that the changed one or more words fits the generated description of the task or expectation. At step 612, the system stores the description of the task or expectation in a non-transitory computer-readable memory. The method ends at step 614.

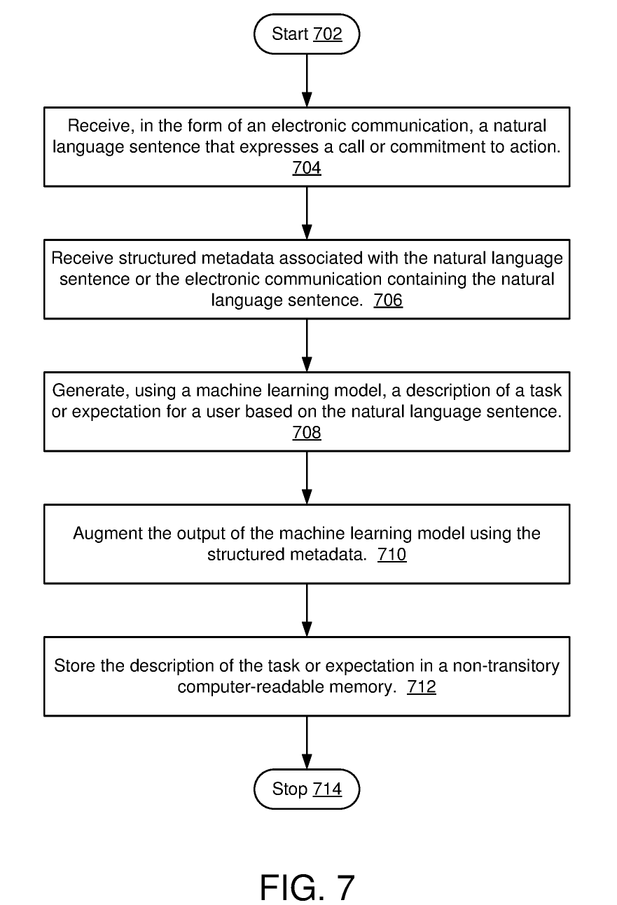

FIG. 7 shows an exemplary flowchart of a computer-implemented machine learning method for automatically generating natural language task descriptions and/or expectation description using structured metadata. Given structured metadata, such as the sender of the electronic communication containing the natural language sentence, it is possible to use that metadata to augment the output of the machine learning model with information including, but not limited to, recipients and time. The method begins at step 702. At step 704, the system receives, in the form of an electronic communication, a natural language sentence that expresses a call or commitment to action. At step 706, the system receives structured metadata associated with the natural language sentence or the electronic communication containing the natural language sentence. At step 708, in response to receiving the electronic communication, the system automatically generates, using a machine learning model, a description of a task or expectation for a user based on the natural language sentence. At step 710, in response to receiving the structed metadata associated with the natural language sentence, the system augments the output of the machine learning model using the structured metadata. At step 712, the system stores the description of the task or expectation in a non-transitory computer-readable memory. The method ends at step 714.

At least one embodiment of the present invention is directed to a computer program encoded in a non-transitory computer-readable memory. The computer program comprises computer-executable instructions that, when executed, causes one or more computer systems to perform embodiments of the present invention described herein. The term “computer system” as used herein refers to any data processing system or computer system including, but not limited to, personal computers (PC), file servers, cloud computing systems, software-as-a-service (SaaS) systems, cellular telephones, smartphones, tablet devices, laptop computers, personal digital assistants, and the like. The computer program can comprise one or more smartphone/tablet applications, web-based applications, native personal computer applications, progressive web applications, and the like.

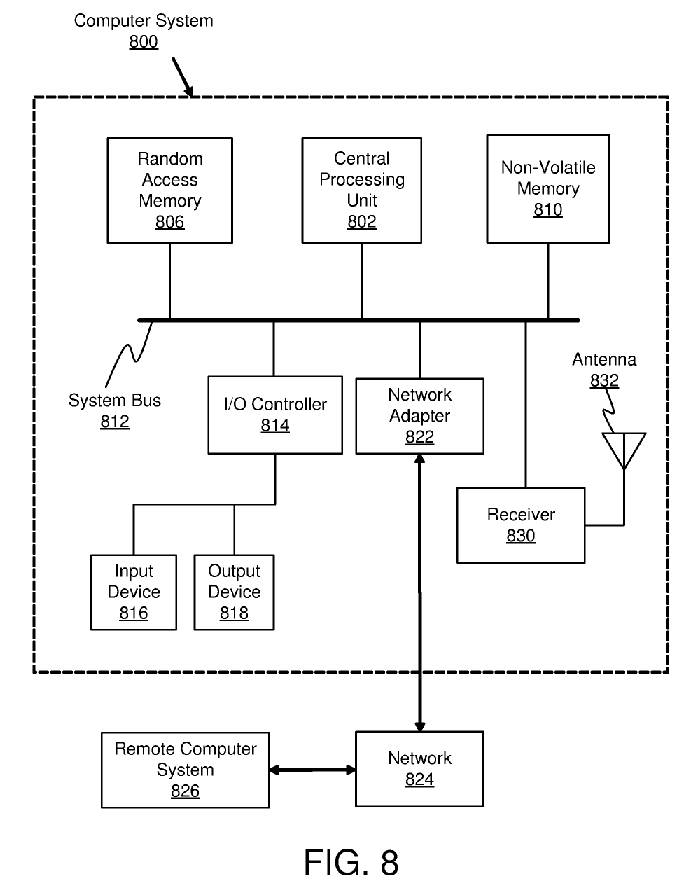

FIG. 8 is a block diagram showing a computer system 800 suitable for storing and/or executing a computer program in accordance with embodiments of the present invention. Computer system 800 includes a central processing unit 802 having at least one microprocessor. Central processing unit 802 can be coupled directly or indirectly to memory elements through system bus 812. The memory elements comprise computer-readable memory capable of storing computer-executable instructions. The memory elements can include random access memory 806 employed during the actual execution of the program code and non-volatile memory 810 for longer term storage of data and instructions.

One or more input devices 816 and output devices 818 can be coupled to system bus 812 either directly or through an intervening input/output (I/O) controller 814. Examples of input device 816 include, but are not limited to, a pointing device, such as a mouse or a trackpad, or a keyboard. Examples of output device 818 include, but are not limited to, a display screen or a printer. Input device 816 and output device 818 can be combined into a single device, for example, as a touchscreen comprising a display screen (for displaying output to the user of computer system 800) having a touch-sensitive surface (for receiving input from the user of computer system 800).

One or more network adapters 822 may also be coupled to computer system 800 to enable the system to become communicatively coupled to remote computer system 826 or remote printers or storage devices through intervening private or public networks 824. Modems, cable modems, Ethernet cards, and wireless network adapters are just a few of the currently available types of network adapters. Computer system 800 can include one or more receivers 830. Receiver 830 receives wireless signals via antenna 832. Receiver 830 is adapted for receiving a data signal from a transmitting device. Receiver 1130 can comprise a transceiver capable of both transmitting and receiving wireless data signals, including but not limited to, wireless local area networking, Wi-Fi, Bluetooth, cellular radio signals (GSM, CDMA, UMTS, LTE, etc.), global positioning system (GPS) signals, near field communication (NFC) signals, and the like. While various component devices of computer system 800 are shown as separate component devices in FIG. 8 for purposes of description, the various component devices may be integrated into a single device, as is known in the art, such as a system-on-a-chip (SoC) device.

Although the present invention and its advantages have been described in detail, it should be understood that various changes, substitutions and alterations can be made herein without departing from the scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A computer-implemented machine learning method for automatically generating a description of a task or expectation, the method comprising:
receiving, in the form of an electronic communication, a natural language sentence that expresses a call or commitment to action;
generating, using a machine learning model, a description of a task or expectation for a user based on the natural language sentence; and
storing the description of the task or expectation in a non-transitory computer-readable memory.

2. The computer-implemented machine learning method of claim 1, further comprising:
receiving a semantic annotation of the natural language sentence, the semantic annotation including one or more labels; and
generating the description so that the description explicitly states the type of action that the user should perform or anticipate.

3. The computer-implemented machine learning method of claim 2, in which the one or more labels are manually assigned or predicted.

4. The computer-implemented machine learning method of claim 2, in which the one or more labels are derived from a hierarchical ontology of actions.

5. The computer-implemented machine learning method of claim 1, further comprising:
determining whether the natural language sentence exceeds a predetermined word limit or includes discourse markers or irrelevant information; and
in response to the natural language sentence exceeding a predetermined word limit or includes discourse markers or irrelevant information, training the machine learning model to truncate the natural language sentence so that only a portion of the natural language sentence related to the description of the task or expectation is kept.

6. The computer-implemented machine learning method of claim 1, further comprising:
receiving contextual knowledge describing a desired action; and
generating the description of the task or expectation so that the description explicitly states a constraint or suggestion to the desired execution of the task or expectation.

7. The computer-implemented machine learning method of claim 6, in which the constraint or suggestion indicates one or more of a desired communication medium, a time, or a location.

8. The computer-implemented machine learning method of claim 1, further comprising:
determining one or more morphosyntactic characteristics of one or more of the words in the natural language sentence; and
changing, using the machine learning model, the one or more morphosyntactic characteristics of the one or more words of the natural language sentence so that the changed one or more words fits the generated description of the task or expectation.

9. The computer-implemented machine learning method of claim 1, further comprising:
receiving structured metadata associated with the natural language sentence or the electronic communication containing the natural language sentence; and
augmenting an output of the machine learning model using the structured metadata.

10. The computer-implemented machine learning method of claim 1, in which the structured metadata is selected from a group consisting of: an indication of sender of the electronic communication containing the natural language sentence, an indication of the recipient of the electronic communication containing the natural language sentence, and an indication of a time of the electronic communication containing the natural language sentence.

11. A computer system comprising:
a processor;
a network adapter coupled to the processor for receiving signals from a third-party system and sending signals to the third-party system;
a computer-readable memory coupled to the processor, the computer-readable memory programmed with computer-executable instructions that, when executed by the processor, cause the computer system to perform the steps of:
receiving, in the form of an electronic communication, a natural language sentence that expresses a call or commitment to action;
generating, using a machine learning model, a description of a task or expectation for a user based on the natural language sentence; and
storing the description of the task or expectation in a non-transitory computer-readable memory.

12. The computer system of claim 11, further programmed for:
receiving a semantic annotation of the natural language sentence, the semantic annotation including one or more labels; and
generating the description so that the description explicitly states the type of action that the user should perform or anticipate.

13. The computer system of claim 12, in which the one or more labels are manually assigned or predicted.

14. The computer system of claim 12, in which the one or more labels are derived from a hierarchical ontology of actions.

15. The computer system of claim 11, further programmed for:
determining whether the natural language sentence exceeds a predetermined word limit or includes discourse markers or irrelevant information; and
in response to the natural language sentence exceeding a predetermined word limit or includes discourse markers or irrelevant information, training the machine learning model to truncate the natural language sentence so that only a portion of the natural language sentence related to the description of the task or expectation is kept.

16. The computer system of claim 11, further programmed for:
receiving contextual knowledge describing a desired action; and
generating the description of the task or expectation so that the description explicitly states a constraint or suggestion to the desired execution of the task or expectation.

17. The computer system of claim 16, in which the constraint or suggestion indicates one or more of a desired communication medium, a time, or a location.

18. The computer system of claim 11, further programmed for:
determining one or more morphosyntactic characteristics of one or more of the words in the natural language sentence; and
changing, using the machine learning model, the one or more morphosyntactic characteristics of the one or more words of the natural language sentence so that the changed one or more words fits the generated description of the task or expectation.

19. The computer system of claim 11, further programmed for:
receiving structured metadata associated with the natural language sentence or the electronic communication containing the natural language sentence; and
augmenting an output of the machine learning model using the structured metadata.

20. The computer system of claim 11, in which the structured metadata is selected from a group consisting of: an indication of sender of the electronic communication containing the natural language sentence, an indication of the recipient of the electronic communication containing the natural language sentence, and an indication of a time of the electronic communication containing the natural language sentence.
